(19) United States
(12) Patent Application Publication
(10) Pub. No.: US 2011/0109150 A1
(43) Pub. Date: May 12, 2011

(54) SIZED SPOKE WEIGHT

(76) Inventors: Michael A. MCCULLOCH, Warrenton, MO (US); James J. NOVELLI, Wright City, MO (US)

(21) Appl. No.: 12/615,546

(22) Filed: Nov. 10, 2009

(51) Int. Cl. B60B 19/00

(52) U.S. Cl. 301/5.21

(57) ABSTRACT

A sized spoke weight has a partially cylindrical body with a longitudinal slot, and a first end and an opposite second end. The first end locates towards the hub of a wheel when installed and the second end locates towards the nipple of a spoke, that is, towards the rim of a wheel. The slot extends from the first end to the second end and allows the sized spoke weight to fit over an existing spoke and nipple. Proximate the second end, the slot has a greater diameter to accommodate an existing nipple during installation. The length and diameters of the sized spoke may be adjusted to provide various weights for users. The sized spoke weight is generally made of brass and has various sizes with corresponding weights for wheel balancing. The present invention minimizes environmental contamination.

### BACKGROUND OF THE INVENTION

The sized spoke weight generally relates to motorcycle accessories and more specifically to balancing wheels with weights fitted to the spokes of a wheel.

After purchase, an owner often takes a motorcycle on rides on a road or off the road. For both surface conditions, motorcycle owners generally seek a smooth ride. A smooth ride begins with the surface and then the motorcycle accommodates surface imperfections, bumps, and curves through the tires, wheels, and suspension system. The wheels and suspension system isolate and dampen the wheel and chassis impacts perceived by the owner as not a smooth ride.

The tires engage the road or other surface. Solid tires transmit surface impact forces directly through the tires into the wheel. Pneumatic tires flex and bend with impact forces and transmit less force to the wheel. Over time, tires wear with use yet the suspension system accommodates wearing of a tire as the suspension system adjusts. The suspension system, being mechanical with some dampening by compressible fluids such as air or selected liquids, attenuates or smoothes the impact forces sent into the suspension system. The suspension system adjusts and meets the impact forces within design limits of the system. Barring mechanical failure, the suspension system operates throughout its design range with little adverse affect on the owner.

Turning intermediate the tires and the suspension system of a motorcycle, the wheels provide a mechanical link from the tires to the suspension system and chassis of a motorcycle. Each wheel, generally metallic or high strength composite fiber, has a rim that receives and secures a tire thereon. Unless the wheel has a solid construction, the hub locates spaced away from the rim upon at least three spokes. A spoke extends from the hub to the rim, supports the weight of the motorcycle, owner, and cargo, and endures the forces from the surface while the motorcycle rides along. Through three spokes can support a hub, generally wheels have a plurality of spokes. As the number of spokes rises, the size of each spoke can decreases. As a wheel turns, the spokes turn with the wheel and transmit forces to the hub and on into the suspension system.

Upon manufacturing and later after certain impacts, a wheel has or acquires select tiny imperfections in its weight or geometry. These imperfections cause a wheel to rotate about an axis not perpendicular to the path of travel of the wheel, about an axis not perpendicular to the longitudinal centerline of a motorcycle, or both. In brief, the wheel wobbles. For minor wobbles, the spokes flex and dampen the wobble, unnoticed by the owner. For noticeable wobbles, the spokes transmits wobbles and the owner notices them. Noticeable wobbles also wear tires unevenly and cause the owner to adjust their steering position so the motorcycle travels straight though the handlebars become askew. Wobbles though can be mitigated through balancing of a wheel.

### DESCRIPTION OF THE PRIOR ART

In bays and shops around the world, numerous tires are changed from wheels every day and wheels return to shops for inspection. During a tire change, a worn or damaged tire is removed from a wheel and a new tire is installed. During an inspection, a mechanic checks a wheel for abnormalities along with the complaints of an owner. Following a tire change or upon an adverse inspection, a wheel is balanced by spinning it upon its axis through the center. By a balancing machine or visual or auditory means, a mechanic determines where the wheel is out of balance and so marks the tire or the wheel with chalk or other marker. The mechanic then places lead weights upon the wheel at the marks, hammers the weights in place upon the rim, and spins the weighted wheel to check for balance shown by the absence of vibration. The positioning, marking, weighting and checking are repeated until the wheel balances.

Some bays and shops use manual equipment for balancing of wheels, particularly static balancing. Manual balancing involves a stand that supports a rod upon which a wheel turns. The vertical stand maintains the rod generally horizontal so a wheel rotates within a vertical plane. In the vertical plane, the wheel balancing occupies a minimum of floor space, useful to small and crowded shops. As the wheel turns, a mechanic notes, with chalk or other marker, points on the wheel that are out of balance. The mechanic then attaches weights upon the marked places of a rim. The mechanic then spins the wheel to check its balance, when the wheel stops at any point of rotation, it has achieved a static balance. If necessary, the weighting and checking is repeated until the wheel achieves a balanced state.

Wheels are used on many vehicles. On utility vehicles, the appearance of wheels matters less so than on personal vehicles. For automobiles, motorcycles, and some boat trailers, the wheels and their appearance have high importance to their drivers. People often place great emphasis on the appearance of wheels as part of their self image. The after market in wheels of all kinds is huge. Often, people seek out shiny, or novelty, wheels to customize vehicles. In particular, motorcycles have shiny wheels including spokes and rims. The shine upon the wheels arises from chrome a metal alloy, or metal plating, upon the wheel, particularly the rim. Alloys and plating are readily damaged by harder materials usually contained in shop tools and equipment that shop tools and equipment are known to mar wheels. The owners of shiny wheels have little tolerance for shop caused blemishes upon their wheels.

Traditionally, wheels, even shiny wheels, have been clamped for tire balancing and other procedures. Metal clamps grip the hub of a wheel snugly upon an axle that is then rotated to find the light point of a wheel. Across the diameter from the light point is the theoretical heavy point of a wheel. A properly sized lead weight placed and hammer at the light point offsets the heavy point so the wheel becomes balanced. The lead weights abrade the wheels over time, react with the metals of the wheel leading to discoloration, and in time may fall off the wheel. For some wheels, lead weights are applied using tape over the weight or as a weighted tape adhered to the surface of the rim. In time, the tape fails and the weight falls off the wheel leaving a difficult to remove tape residue. Lead weights can become an environmental hazard as they degrade on the side of a road or enter a waterway.

Unlike wheel weights wedged upon the rim, spoke weights also balance a wheel. The spoke weights prove useful to wheels with many spokes thus allowing for a spoke to be located at a balance point of a wheel. The spoke weights have various sizes and secure to a spoke. Existing weights secure to a spoke by crimping using a pair of pliers or special compressive tool. A spoke also has a nipple connecting it to the rim of a wheel. The nipple is generally located upon a spoke opposite its connection to a hub. The nipple reinforces the spoke proximate a zone of maximum shear at the rim. The nipple is generally wider, or of greater diameter, than the spoke and has a short length inwardly from the rim. Existing spoke weights have a central opening that admits a spoke but does not fit upon a nipple. A central opening sized for a nipple would be bigger than the spoke width leading to the spoke weight falling from the spoke when a wheel ceases rotation.

The present invention overcomes the difficulties of marring a wheel by weights adjoining a rim, locating spoke weights inwardly from a nipple and the rim, and leaving a tape residue upon a wheel. The present invention uses materials less toxic to the environment and allows for reuse of spoke weights.

### SUMMARY OF THE INVENTION

Generally, the sized spoke weight has a partially cylindrical body with a longitudinal slot, and a first end and an opposite second end. The first end locates towards the hub of a wheel when installed and the second end locates towards the nipple of a spoke, that is, towards the rim of a wheel. The slot extends from the first end to the second end and allows the sized spoke weight to fit over an existing spoke. Proximate the second end, the slot has a greater diameter to accommodate an existing nipple during installation. The sized spoke weight is generally brass and has various sizes with corresponding weights for wheel balancing.

There has thus been outlined, rather broadly, the more important features of the invention in order that the detailed description thereof that follows may be better understood and that the present contribution to the art may be better appreciated. The present invention also includes a set screw proximate the second end, a frusto-conical shape to the first end, and a bevel upon the end of the slot proximate the second end. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a size spoke weight that fits over existing spokes and secures to existing nipples.

Another object is to provide such a size spoke weight that does not use adhesives or tapes.

Another object is to provide such a size spoke weight that resists degradation by the environment and does not contribute to environmental pollution.

Another object is to provide such a size spoke weight that has a low cost of manufacturing so the purchasing consumers and organizations can readily buy the size spoke weight through stores and supply sources.

These together with other objects of the invention, along with the various features of novelty that characterize the invention, are pointed out with is particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows a perspective view of an existing spoke, an alternate embodiment of the invention installed upon a spoke, and the preferred embodiment of the invention in two sizes installed upon spokes;

FIG. 2 describes a top view of the alternate embodiment;

FIG. 3 provides a side view of the alternate embodiment;

FIG. 4 shows a top view of the preferred embodiment of the sized spoke weight;

FIG. 5 illustrates a side view of the preferred embodiment of the invention; and,

FIG. 6 shows a bottom view of the preferred embodiment.

The same reference numerals refer to the same parts throughout the various figures.

### DESCRIPTION OF THE PREFERRED EMBODIMENT

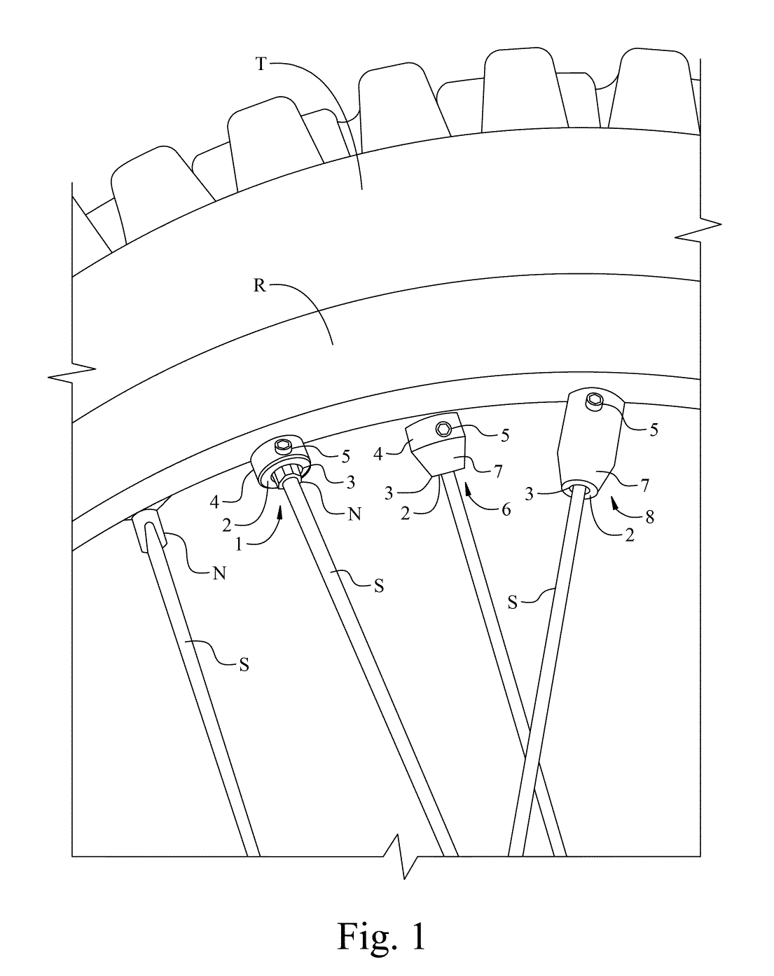

The present art overcomes the prior art limitations by providing a sized spoke weight that fits upon a spoke nipple and secures itself upon the nipple without adhesive. FIG. 1 shows a tire T upon a rim R supported by spokes S extending from a hub, not shown. From left to right, FIG. 1 illustrates a connection of a spoke S to the rim R using an existing nipple N. The nipple has a greater diameter than the spoke though less length than the spoke. Moving to the right of the figure, an alternate embodiment of the invention, as at 1, secures to another nipple. The alternate embodiment of the weight is generally cylindrical with a first end 2 here shown inwardly from the rim R. The weight 1 has a slot 3 extending radially with a width slightly larger than the diameter of a nipple. The slot passes through the full depth of the weight. Being cylindrical, the weight has an outer surface, similar to a wall, as at 4. The outer surface has a setscrew 5 threaded into an aperture so that the setscrew extends through the weight and abuts the nipple. The set screw advances radially through the outer surface. Upon turning the setscrew, a user secures this alternate embodiment of the weight to the nipple. Generally the alternate embodiment has a depth less than the length of a nipple.

Next right from the alternate embodiment, this figure shows the preferred embodiment of the weight as at 6. This embodiment of the weight also has a generally cylindrical shape with a first end 2 locating inwardly. Here the weight widens in a frusto conical manner outwardly from the first end towards the rim as at 7. The first end has a lesser diameter than the remainder of the weight. Approximately midway along the depth of the weight, the weight widens to its maximum diameter outwardly from the frusto-conical portion. The weight has a setscrew 5 that extends through a threaded aperture in the outer surface 4 to abut the nipple. The set screw advances radially through the outer surface. Turning of the setscrew secures the weight to the nipple. Before securing the setscrew, a user installs the weight upon the spoke and the nipple by passing the them into a slot 3. The slot extends radially for the depth of the weight and has a width slightly larger than the diameter of the nipple and larger than the diameter of the spoke. The weight in the preferred embodiment has a depth greater than the length of the nipple.

And, to the right of FIG. 1, an elongated version of the preferred embodiment of the weight is shown as at 8. This weight has a generally cylindrical form with a first end 2 locating towards the hub of the wheel. The weight widens in diameter in a frusto-conical manner outwardly from the first end to before the midpoint of the depth of the weight. The weight then continues at a constant and maximum diameter for the remained, that is, the majority of its length to the rim. As before, the weight has an outer surface 4 generally defining the cylindrical shape and a setscrew 5 that extends through a threaded aperture in the outer surface 4 to abut the nipple. The set screw advances radially through the outer surface. Turning of the setscrew secures the weight to the nipple. In both the alternate and the preferred embodiments, the aperture and the setscrew locate towards the rim and opposite the first end 2. Before securing the setscrew, a user installs the weight upon the spoke and the nipple by passing them into a slot 3. The slot extends radially for the depth of the weight and has a width slightly larger than the diameter of the nipple and larger than the diameter of the spoke. As before, this embodiment of the weight has a depth greater than the length of the nipple and the depth has various lengths proportional to the desired amount of weight needed to balance a wheel.

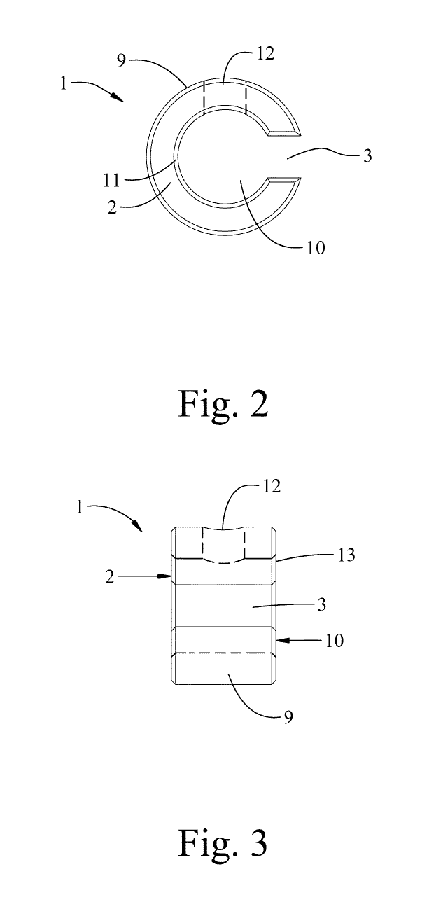

Viewing the alternate embodiment 1 of the spoke weight from an end, FIG. 2 shows the first end 2 of the sized spoke weight before installation upon a spoke. This weight, as at 1, has an outer surface 4, here shown generally round, that defines a body 9 generally cylindrical. The body, generally hollow, has an opening 10 sized to fit over a typical nipple N as shown in FIG. 1. The opening is generally round and makes the weight hollow. The body has a thickness proportional to the desired weight of the invention for usage. The thickness extends from the outer surface 4 inwardly to the perimeter of the opening 10. Then the body has a lengthwise slot 3 through its thickness from the outer surface into the opening. The slot extends parallel to a radius from the center of the opening but not across the diameter of the first end 2. The slot extends slightly beyond the longitudinal axis, or centerline, of the body. Thus the slot forms the first end into a generally letter C shape as shown. The opening adjoins the first end 2 and the body has a beveled edge condition as at 11 around the perimeter of the opening. The beveled edge condition guides the invention to seat upon an existing nipple. Midway along the length of the body, the body has an aperture 12 extending through its thickness. The aperture has internal threads that engage the threads of the setscrew 5. In usage, a user turns the setscrew into the nipple which shifts the body tightly upon the nipple opposite the aperture. The setscrew secures the weight 1 upon the nipple to prevent rotation of it and eventual dislodgement. Though shown perpendicular to the slot 3, the aperture 12 may have an orientation at another angle to the slot convenient for users.

Turning the alternate embodiment of the weight 1 once more, FIG. 3 shows this embodiment of the invention from the side. The body 9 has a first end 2, towards the left, and an opposite second end 13, towards the right in the figure. The first end and the second end are generally mirror images of each other to permit a user to install this embodiment with either end towards the rim R. As above, the body 9 has an outer surface 4 through which a slot 3 passes. The slot extends for the length of the weight and has a width to admit a spoke. Here shown in phantom above the slot, the body has its aperture 12 threaded therein to receive a setscrew. The slot communicates into an opening 10 that extends from the first end 2 through the body for its entire length to the second end 13. The opening allows this embodiment of the weight to snugly rest upon a nipple proximate the rim R.

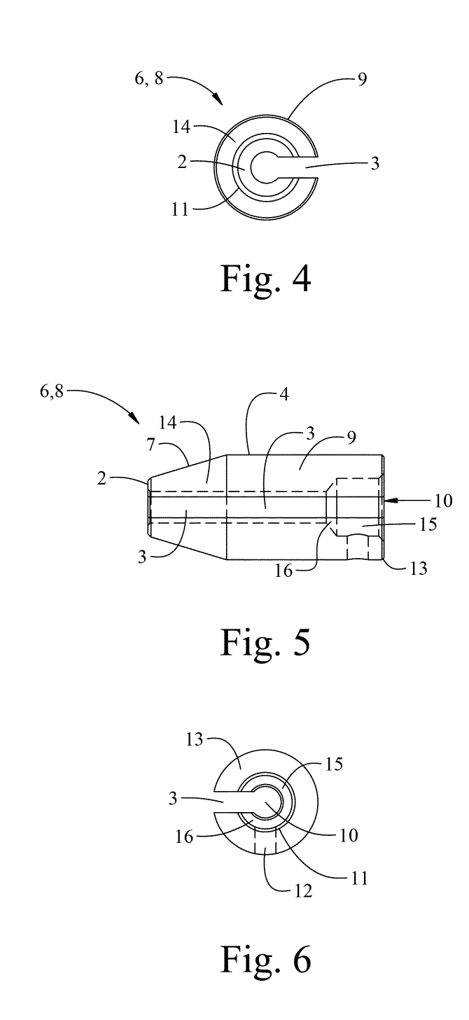

Then FIG. 4 shows an end view of the preferred embodiment. The preferred embodiment has its first end 2, generally round of a first diameter with a perimeter. The perimeter of the first end has a slight bevel, as at 11, that smoothes the transition from the first end to the remainder of the body 9 of the weight. The body has a second diameter generally greater than the first diameter. The body tapers from its second diameter towards the perimeter of the first end as at 14. As described previously, the outer surface 4, here shown generally round, that defines the body 9 as a cylinder. The body has a thickness proportional to the desired weight of the invention for usage. The thickness extends from the outer surface 4 inwardly though the taper modifies the thickness rearwardly of the first end. Then the body has a lengthwise slot 3 through its thickness from the outer surface to a centerline of the weight. The slot extends parallel to a radius from the center of the weight outwardly but not across the diameter of the first end 2. Thus the slot forms the first end into a generally letter C shape as shown. The first end 2 has a beveled edge condition as at 11 around the perimeter of the first end but interrupted by the slot.

From the side, the preferred embodiment is shown in FIG. 5. The spoke weight of the preferred embodiment 6 begins with the first end 2 upon the left of the figure. The first end has a first diameter less than the second diameter of the body. The body transitions in diameter from the first end 2 through a taper 14 to the body 9 of the spoke weight. The taper creates a frusto-conical shape, as at 7, to the body proximate the first end 2. The body extends away from the first end towards the second end 13 generally opposite the first end and having a greater diameter than the first end. Along the length of the spoke weight, a slot 3 extends from the first end 2 through the taper section as at 7 along the body 9 to the second end 13. The slot has a width generally that of the diameter of a spoke S.

Here shown in phantom below the slot towards the second end 13, the spoke weight has its aperture 12, internally threaded to receive a setscrew. The slot communicates into an opening 10 that extends from the second end 13 as a socket 15 into the body but much less than its length. The opening allows this embodiment of the spoke weight to snugly rest upon a nipple proximate the rim R as previously shown in FIG. 1. The opening 10 has a diameter to fit over a typical nipple N as previously shown. The opening is generally round and makes the weight hollow. The body has its first diameter, second diameter, and length, proportional to the desired weight of the invention for usage. The manufacturer can adjust any of those three dimensions and produce a spoke weight of a desired weight whether in ounces or grams. The opening generally has a bevel 11 that leads into the socket 15 here shown from the side. The socket extends away from the second end 13 into the body for a length sufficient to admit a typical nipple. The socket also has a diameter to accommodate the shape of a typical nipple. Opposite the opening, the socket ends in a base 16 of sharply decreasing diameter, effectively an abrupt taper to the diameter of the slot. And in this embodiment, the aperture 12 communicates into the socket 15. As above, the internally threaded aperture engages the threads of a setscrew 5 (not shown). In usage, a user turns the setscrew into the aperture and onto the nipple which shifts the body tightly upon the nipple opposite the aperture. The setscrew secures the spoke weight 1 upon the nipple to prevent its rotation, slippage, and eventual dislodgement.

And then FIG. 6 shows the second end 13 of the preferred embodiment of the spoke weight. The second end generally has the second diameter that defines the size of the body 9 for the spoke weight. The second end is generally perpendicular to the outer surface 4 of the body and opposite the first end 2 previously shown in FIG. 4. The second end includes a termination of the slot 3 shown extending from the outer surface 4 inwardly to the center of the second end, forming a reversed letter C shape. The second end also has the socket 15 extending into the body 9 of the spoke weight. The socket adjoins the second end at the bevel 11 of the opening 10. The socket is generally round and narrows the body to having a thickness for the length of the socket that shapes the body to have the desired weight of the invention for usage while fitting upon a nipple N. The thickness extends from the outer surface 4 inwardly to the perimeter of the opening 10 for the depth of the socket. Away from the socket, the body has its full diameter broken only by the slot. The socket extends into the body to its base 16 here shown as the interior of the reverse C shape.

Though FIGS. 4-5 show the preferred embodiment of the invention, the Applicants foresee adjustments to the length of the body 9 and to the first diameter and the second diameter. These adjustments produce spoke weights of certain weights and allow for some aesthetic features of the spoke weight as desired by the users.

From the aforementioned description, a sized spoke weight has been described. The sized spoke weight is uniquely capable of securing to a spoke over a nipple and thus balancing a wheel. The sized spoke weight has various dimensions leading to a variety of weights available for specific balancing situations. The sized spoke weight and its various components may be manufactured from many materials, including but not limited to, brass, bronze, steel, aluminum, polymers, polyvinyl chloride, high density polyethylene, polypropylene, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

We claim:

1. A device for balancing a wheel with spokes, each of said spokes connecting to a nipple, said device comprising:
a body, generally cylindrical, having a length and a longitudinal axis, a first end and an opposite second end joined by an outer surface therebetween;
said body having an opening proximate said adapting to admit a nipple and said opening locating proximate said second end;
said body having a slot extending for the length of said body from said first end to said second end, said slot having a depth from said outer surface to said opening proximately to the longitudinal axis and a width adapting to admit a spoke; and,
said body having an internally threaded aperture from said outer surface to said opening and a setscrew engaging said aperture;
is wherein said length of said body allows for precise determination of the weight of said device.

2. The wheel with spokes balancing device of claim 1 further comprising:
said first end and said second end having a similar diameter; and,
the length of said body adapting to be less than the length of a nipple.

3. The wheel with spokes balancing device of claim 1 further comprising:
said first end having a lesser diameter than said second end; and,
the length of said body adapting to exceed the length of a nipple.

4. The wheel with spokes balancing device of claim 3 further comprising:
said body enlarging in diameter from said first end to partially along the length of said body and the remainder of said body having the same diameter as said second end.

5. The wheel with spokes balancing device of claim 4 further comprising:
said opening forming a socket extending into said body inwardly from said second end for a depth adapted to admit a nipple;
said socket having a diameter less than said second end and a depth less than the length of said body; and,
said aperture communicating to said socket.

6. The wheel with spokes balancing device of claim 1 wherein said opening is beveled proximate said second end.

7. The wheel with spokes balancing device of claim 1 wherein first end is beveled.

8. A device for balancing a wheel having a tire upon a rim supported by spokes where each spoke connects to the rim with a nipple, said device comprising:
a generally cylindrical body having a length and a longitudinal axis, a first end and an opposite second end joined by an outer surface;
an opening proximate said second end adapting to admit a nipple wherein said body rests adjacent to the rim;
a slot extending from said first end to said second end, said slot having a depth from said outer surface to said opening proximate to the longitudinal axis and a width adapting to admit a spoke, said slot defining a thickness of said body; and,
an internally threaded radial aperture from said outer surface through the thickness to said opening and a setscrew engaging said aperture thus allowing for securement of said device upon a nipple.

9. The wheel with spokes balancing device of claim 8 further comprising:
said body having a frusto conical shape inwardly of said first end enlarging to the diameter of said second end approximately midway along said body;
said opening extending inwardly into said body forming a socket having a diameter and a depth adapting to receive a nipple, said socket having a base opposite said opening; and,
said aperture communicating to said socket.

10. The wheel with spokes balancing device of claim 9 wherein said opening is beveled proximate said second end and said first end is beveled; and, wherein adjustment of the length and the thickness of said body allows for precise determination of weight for said device.
